(19) United States
(12) Patent Application Publication
(10) Pub. No.: US 2026/0204675 A1
(43) Pub. Date: Jul. 16, 2026

(54) BATTERY COOLING APPARATUS

(71) Applicant: ISUZU MOTORS LIMITED, Yokohama-shi (JP)

(72) Inventor: Kenichiro TSUDA, Fujisawa-shi (JP)

(21) Appl. No.: 19/417,907

(22) Filed: Dec. 12, 2025

(30) Foreign Application Priority Data
Jan. 15, 2025 (JP) 2025-005262

(51) Int. Cl. H01M 10/633; H01M 10/613; H01M 10/6569

(52) U.S. Cl. CPC H01M 10/633; H01M 10/613; H01M 10/6569

(57) ABSTRACT

A battery cooling apparatus includes: a battery case that houses a refrigerant and a battery with at least a part thereof immersed in the refrigerant; a first refrigerant flow path through which the refrigerant, a portion of which is supplied to the battery case, and vapor generated by vaporization of the refrigerant flow; and an ejector through which the refrigerant and the vapor pass, wherein the ejector includes a nozzle into which the refrigerant flows, a suction unit that draws in the vapor contained in the battery case as the refrigerant passes through the ejector, and a discharge unit that discharges the refrigerant and the vapor into the first refrigerant flow path.

### CROSS-REFERENCE TO RELATED APPLICATIONS

The present application claims priority to Japanese Patent Application number 2025-005262, filed on January 15, 2025, contents of which are incorporated herein by reference in its entirety.

### BACKGROUND OF THE INVENTION

The present disclosure relates to a battery cooling apparatus. In a conventional battery device, a coolant is stored in a battery case, and a part of a cooling body that comes into contact with the battery and a part of the battery are immersed in the coolant. The battery device generates the coolant by cooling and condensing refrigerant vapor produced through evaporation of the coolant that has exchanged heat with the cooling body, and cools the battery by returning the coolant into the battery case (for example, Japanese Unexamined Patent Application Publication No. 2016-146298).

### BRIEF SUMMARY OF THE INVENTION

When the temperature of the coolant rises to its boiling point through heat exchange with heat generated by the battery, the coolant evaporates. In a case where the temperature of the battery increases but the temperature of the coolant does not reach the boiling point, the coolant does not evaporate, and thus the battery device cannot reduce the temperature of the battery efficiently. As a result, degradation of the battery may be accelerated. Furthermore, when the battery is a lithium-ion battery, since the temperature range in which degradation can be suppressed is limited, it is desirable to efficiently lower the temperature of the battery by appropriately evaporating the coolant at a boiling point suitable for the battery.

The present disclosure has been made in view of these points, and an object of the present disclosure is to facilitate evaporation of a coolant.

A battery cooling apparatus including: a battery case that houses a refrigerant, which is a liquid for cooling a battery, and a battery with at least a part thereof immersed in the refrigerant; a first refrigerant flow path through which the refrigerant, a portion of which is supplied to the battery case, and vapor generated by vaporization of the refrigerant flow; and an ejector provided in the first refrigerant flow path and through which the refrigerant and the vapor pass, wherein the ejector includes a nozzle into which the refrigerant flowing through the first refrigerant flow path flows, a suction unit that draws in the vapor generated by the vaporization of the refrigerant contained in the battery case as the refrigerant passes through the ejector, and a discharge unit that discharges the refrigerant that has flowed into the nozzle and the vapor drawn in by the suction unit into the first refrigerant flow path.

### BRIEF DESCRIPTION OF THE DRAWINGS

FIG. 1 is a diagram showing a configuration of a battery cooling apparatus 1.

FIG. 2 is a diagram showing a configuration of the battery cooling apparatus 1 capable of switching the degree of cooling.

FIG. 3 is a diagram showing the battery cooling apparatus 1 performing high cooling.

FIG. 4 is a diagram showing the battery cooling apparatus 1 performing low cooling.

FIG. 5 is a diagram showing the temperature of batteries 22 corresponding to the degree of cooling.

FIG. 6 is a diagram showing an example of a processing sequence in the battery cooling apparatus 1.

FIG. 7 is a diagram showing a configuration of a battery cooling apparatus 1 according to a fifth modification.

### DETAILED DESCRIPTION OF THE INVENTION

Hereinafter, the invention will be described through embodiments of the invention. The below embodiments, however, are not intended to limit the invention according to the claims, and all combinations of features described in the embodiments are not necessarily essential to the solutions of the invention.

### Configuration of a Battery Cooling Apparatus 1

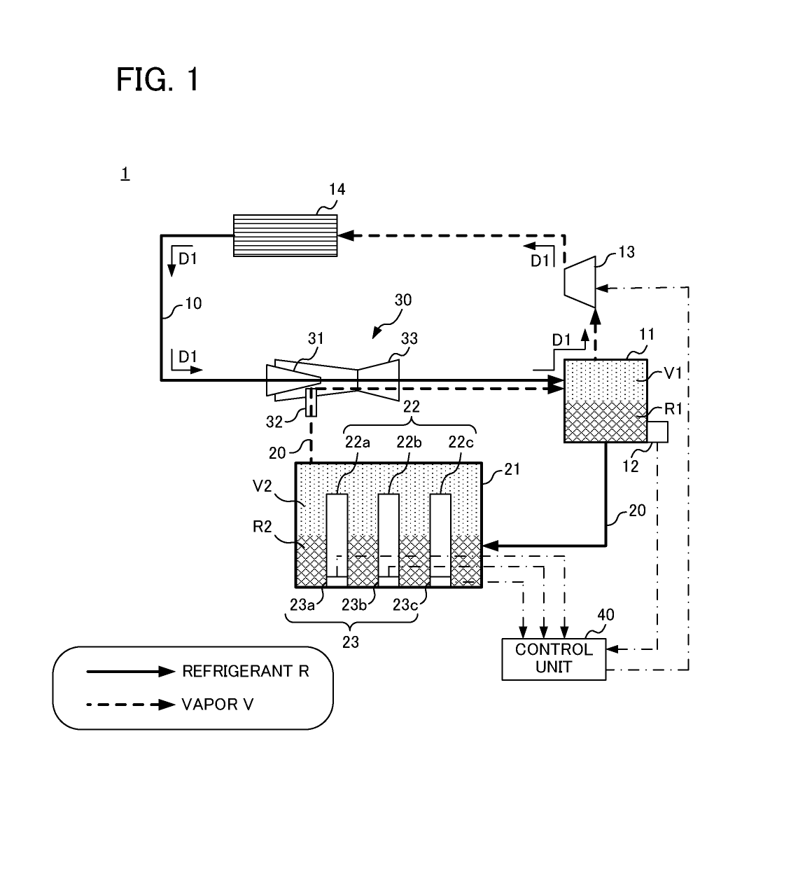

FIG. 1 is a diagram showing a configuration of a battery cooling apparatus 1. The battery cooling apparatus 1 illustrated in FIG. 1 includes a first refrigerant flow path 10, a tank 11, a remaining-amount sensor 12, a compressor 13, a condenser 14, a second refrigerant flow path 20, a battery case 21, a plurality of batteries 22 (22a, 22b, and 22c), a plurality of temperature sensors 23 (23a, 23b, and 23c), an ejector 30, and a control unit 40. The battery cooling apparatus 1 has a function of cooling the batteries 22.

The first refrigerant flow path 10 is a flow path through which refrigerant R, which is a liquid for cooling the batteries 22, and vapor V, which is generated by vaporization of the refrigerant R, flow. In FIG. 1, the portions through which the refrigerant R flows are indicated by solid lines, and portions through which the vapor V flows are indicated by dashed lines. In the first refrigerant flow path 10, the tank 11, the compressor 13, the condenser 14, and the ejector 30 are provided along a flow direction D1 in which the refrigerant R and vapor V flow.

The tank 11 is a storage tank that is provided downstream of the ejector 30 in the first refrigerant flow path 10 and stores the refrigerant R and the vapor V discharged from the ejector 30. In FIG. 1, refrigerant R1 is shown as the refrigerant R stored in the tank 11, and vapor V1 is shown as the vapor V stored in the tank 11. The vapor V1 includes the vapor V discharged from the ejector 30 and the vapor V generated by vaporization of a portion of the refrigerant R1 in the tank 11. The remaining-amount sensor 12 is a sensor for detecting the amount of the refrigerant R1 stored in the tank 11.

The compressor 13 is a compressor that is provided downstream of the tank 11 in the first refrigerant flow path 10 and compresses the vapor V1 stored in the tank 11. The compressor 13 draws in the vapor V1 stored in the tank 11 by, for example, a rotary motion of a rotor or a reciprocating motion of a piston, and compresses the vapor V1. The compressor 13 delivers the vapor V obtained by compressing the vapor V1 to the condenser 14. In the following description, an operation in which the compressor 13 rotates the rotor will be described, and the rotational speed of the rotor is referred to as “the rotational speed of the compressor 13”.

The condenser 14 is a condenser that is provided downstream of the compressor 13 and upstream of the ejector 30 in the first refrigerant flow path 10 and condenses the vapor V compressed by the compressor 13 into the refrigerant R. The condenser 14 condenses (cools) the vapor V into liquid refrigerant R by, for example, exchanging heat between the vapor V and air or cooling water. The condenser 14 may have a function as a subcooler for cooling the refrigerant R to a temperature lower than the saturation temperature.

The second refrigerant flow path 20 is a flow path through which the refrigerant R flows from the tank 11 to the battery case 21, and the vapor V flows from the battery case 21 to a suction unit 32 provided in the ejector 30. In other words, the second refrigerant flow path 20 is a flow path that connects the tank 11 and the suction unit 32 via the battery case 21. The battery case 21 is provided downstream of the tank 11 and upstream of the suction unit 32 in the second refrigerant flow path 20.

The battery case 21 is a container that houses the vapor V, the refrigerant R, the batteries 22, and the temperature sensors 23. In FIG. 1, the refrigerant R2 is shown as the refrigerant R housed in the battery case 21, and the vapor V2 is shown as the vapor V housed in the battery case 21. The refrigerant R2 is supplied to the battery case 21 as a portion of the refrigerant R flowing through the first refrigerant flow path 10 flows through the second refrigerant flow path 20 via the tank 11. The vapor V2 is the vapor V that has been generated by vaporization of a portion of the refrigerant R2 contained in the battery case 21 vaporizes. In FIG. 1, the battery case 21 houses the plurality of batteries 22 and the plurality of temperature sensors 23, but the battery case 21 may house one battery 22 and one temperature sensor 23.

The battery case 21 may house metal tabs and bus bars for electrically connecting the respective batteries 22 (22a, 22b, and 22c), holders that fix each of the batteries 22 and the bus bars to the battery case 21, circuits for monitoring the states of the respective batteries 22, and wiring connected to the circuits. Furthermore, the battery case 21 may be provided with a connector for connecting to an external device and a safety valve for discharging high-pressure gas generated in the batteries 22. The metal tabs, bus bars, holders, circuits, wiring, connector and safety valve are omitted in FIG. 1.

The batteries 22 are secondary batteries capable of charging and discharging electricity, and are, for example, lithium-ion batteries. As shown in FIG. 1, at least a part of the batteries 22 is immersed in the refrigerant R2. Specifically, the lower halves of the batteries 22 are immersed in the refrigerant R2. In this way, by immersing the batteries 22 in the refrigerant R2, the batteries 22 are cooled as a result of heat exchange between the batteries 22 and the refrigerant R2 in the battery case 21. In the battery case 21, the refrigerant R2 that has undergone this heat exchange vaporizes, generating the vapor V2. The temperature sensors 23 are sensors for detecting the temperatures of the batteries 22.

The ejector 30 is a device provided in the first refrigerant flow path 10 and through which the refrigerant R and the vapor V pass, and includes a nozzle 31, the suction unit 32, and the discharge unit 33. The nozzle 31 is a nozzle into which the refrigerant R flowing through the first refrigerant flow path 10 flows. The suction unit 32 is a suction nozzle that draws in the vapor V2 generated by the vaporization of the refrigerant R2 contained in the battery case 21, as a result of the refrigerant R passing through the ejector 30. The discharge unit 33 is a diffuser that discharges the refrigerant R that has flowed into the nozzle 31 and the vapor V2 drawn in by the suction unit 32 into the first refrigerant flow path 10.

The ejector 30 causes the Venturi effect by narrowing the flow path of the nozzle 31, through which the refrigerant R passes, and increasing the flow velocity of the refrigerant R in the ejector 30, for example. The ejector 30 draws in the vapor V2 from the suction unit 32 as a result of reducing the pressure in the battery case 21 by utilizing the Venturi effect, for example. Then, the ejector 30 discharges, into the discharge unit 33, the refrigerant R that has flowed into the nozzle 31 and the vapor V2 drawn in by the suction unit 32.

By operating as described above, in the battery cooling apparatus 1, the compressor 13 compresses the vapor V discharged by the ejector 30 from the battery case 21 to the tank 11, and the condenser 14 can condense the compressed vapor V into the refrigerant R. As a result, the battery cooling apparatus 1 can condense the vapor V2, which is vaporized from the refrigerant R2 after exchanging heat with the batteries 22, into the refrigerant R and return the refrigerant R to the battery case 21.

Furthermore, by operating as described above, the pressure in the battery case 21 is reduced, lowering the boiling point of the refrigerant R2. As a result, even if the temperature of the batteries 22 does not reach the boiling point of the refrigerant R2 under the pressure before the reduction in the battery case 21, the refrigerant R2 evaporates, thereby enabling cooling of the batteries 22 to start earlier. Furthermore, even when the temperature of the batteries 22 is higher than the boiling point before the pressure inside the battery case 21 is reduced, the amount of evaporation of the refrigerant R can be increased, or the rate at which the refrigerant R evaporates can be increased.

The control unit 40 includes one or more processors such as a central processing unit (CPU) or an electronic control unit (ECU), and executes programs stored in a storage unit (not illustrated). For example, by executing the programs, the control unit 40 acquires the amount of the refrigerant R1 detected by the remaining-amount sensor 12, the temperatures of the batteries 22 detected by the temperature sensors 23, and the outside air temperature detected by an outside air temperature sensor (not shown). For example, by executing the programs, the control unit 40 also acquires information indicating a request for rapid charging or rapid discharging from an external device, and causes the compressor 13 to rotate. The control unit 40 may include a housing including electronic components, or may be a printed substrate on which the electronic components are mounted.

By causing the compressor 13 to rotate, the control unit 40 delivers, from the compressor 13 to the condenser 14, the vapor V that is obtained by compressing the vapor V1, and condenses the vapor V into liquid refrigerant R. Then, as the refrigerant R passes through the ejector 30, the ejector 30 draws in, from the suction unit 32, the vapor V2 that is generated by vaporization of the refrigerant R2 whose boiling point has been lowered, and discharges the refrigerant R and the vapor V2 to the tank 11. Therefore, it can be said that, by causing the compressor 13 to rotate, the control unit 40 stores, in the tank 11, the vapor V2 vaporized from the refrigerant R2 as the vapor V1, and also stores, in the tank 11, the refrigerant R obtained by condensing the compressed vapor V1 as the refrigerant R1. The pressure difference between the inside of the tank 11 and inside of the battery case 21 causes the refrigerant R1 to be pushed through the second refrigerant flow path 20 and housed in the battery case 21.

The battery cooling apparatus 1 may supply the refrigerant R to the battery case 21 by installing the tank 11 at a height higher than the height at which the battery case 21 is installed. In addition, in the battery cooling apparatus 1, a pump for supplying the refrigerant R from the tank 11 to the battery case 21 may be provided in the second refrigerant flow path 20. In this case, the control unit 40 supplies the refrigerant R1 stored in the tank 11 to the battery case 21 as the refrigerant R2 by causing the pump to rotate.

For example, the control unit 40 causes the compressor 13 to rotate when the temperature of the batteries 22 is equal to or higher than a first threshold value, and stops the rotation of the compressor 13 when the temperature of the batteries 22 is lower than a second threshold value, which is lower than the first threshold value. The first threshold value is the maximum temperature at which degradation of the batteries 22 is unlikely to be promoted, and is, for example, 35°C. The second threshold is the minimum temperature at which degradation of the batteries 22 is unlikely to be promoted, and is, for example, a fixed value of 20°C or higher and 25°C or lower.

The control unit 40 may calculate the maximum temperature of the plurality of batteries 22 detected by the respective temperature sensors 23, cause the compressor 13 to rotate when the maximum temperature is equal to or higher than the first threshold value, and stop the rotation of the compressor 13 when the maximum temperature is lower than the second threshold value. By operating in this manner, the control unit 40 can reduce the power consumption of the compressor 13.

For example, when the outside air temperature is equal to or higher than the second threshold value, the control unit 40 continues to rotate the compressor 13. Then, for example, the control unit 40 calculates the maximum temperature of the plurality of batteries 22 detected by the respective temperature sensors 23, increases the rotational speed of the compressor 13 when the maximum temperature is equal to or higher than the first threshold value, and decreases the rotational speed of the compressor 13 when the maximum temperature is lower than the first threshold value. By operating in this manner, the control unit 40 can start cooling the refrigerant R2 before the temperature of the batteries 22 rises to a temperature equal to or higher than the first threshold value. As a result, the control unit 40 can cool the refrigerant R2 so that the temperature of the batteries 22 falls within a temperature range in which degradation of the batteries 22 is unlikely to be promoted.

In the battery cooling apparatus 1, the higher the rotational speed of the compressor 13, the higher the temperature of the vapor V1 at an output port of the compressor 13, and therefore the amount of the refrigerant R condensed by the condenser 14 increases. As the flow velocity of the refrigerant R increases, the suction speed at which the suction unit 32 draws in the vapor V2 increases, whereby the pressure in the battery case 21 decreases and the refrigerant R2 becomes more likely to vaporize. Therefore, the higher the temperature of the batteries 22, the more the control unit 40 may increase the rotational speed of the compressor 13. For example, the control unit 40 calculates the maximum temperature of the batteries 22 detected by the respective temperature sensors 23, and the higher the maximum temperature, the more the control unit 40 increases the rotational speed of the compressor 13.

By operating in this manner, the higher the temperature of the batteries 22, the more easily the control unit 40 can vaporize the refrigerant R2 that has exchanged heat with the batteries 22, thereby facilitating lowering of the temperature of the batteries 22.

Furthermore, in the battery cooling apparatus 1, as the amount of the refrigerant R1 stored in the tank 11 increases, the amount of the refrigerant R2 stored in the battery case 21 decreases, and thus the amount of the vapor V flowing into the condenser 14 decreases. Therefore, the control unit 40 may control the rotational speed of the compressor 13 on the basis of the amount of the refrigerant R1 stored in the tank 11. As one example, the smaller the amount of the refrigerant R1, the more the control unit 40 increases the rotational speed of the compressor 13. By having the control unit 40 operate in this manner, the higher the rotational speed of the compressor 13, the more easily the suction unit 32 can draw in the vapor V2, and therefore, the smaller the amount of the refrigerant R1, the more easily the flow of the vapor V2 generated by the vaporization of the refrigerant R2 into the condenser 14 via the tank 11 can be facilitated. As a result, in the battery cooling apparatus 1, the smaller the amount of the refrigerant R1, the more easily the cooling of the batteries 22 can be facilitated.

When charging information indicating rapid charging is acquired, the smaller the amount of the refrigerant R1, the more the control unit 40 may increase the rotational speed of the compressor 13. By operating in this manner, in the rapid charging in which the temperature of the batteries 22 is likely to rise, the control unit 40 can increase the amount of the vapor V2 to be drawn in and increase the amount of the vapor V condensed into the refrigerant R by the condenser 14, thereby facilitating cooling of the batteries 22.

The higher the charging and discharging rate of the batteries 22, the greater the amount of heat generated, and therefore the batteries 22 are likely to rise in temperature. When the temperature of the batteries 22 rises rapidly or the outside air temperature is high, the battery cooling apparatus 1 cannot easily cool the batteries 22. In such a state where the batteries 22 are likely to rise in temperature or where the batteries 22 cannot easily be cooled, the battery cooling apparatus 1, having the above configuration, can lower the temperature of the batteries 22. However, in a case where the batteries 22 are less likely to rise in temperature or can be easily cooled, the above configuration may cause the battery cooling apparatus 1 to excessively cool the batteries 22, thereby possibly consuming unnecessary electric power. Therefore, the battery cooling apparatus 1 may be configured to be capable of switching the degree of cooling (so-called high cooling and low cooling).

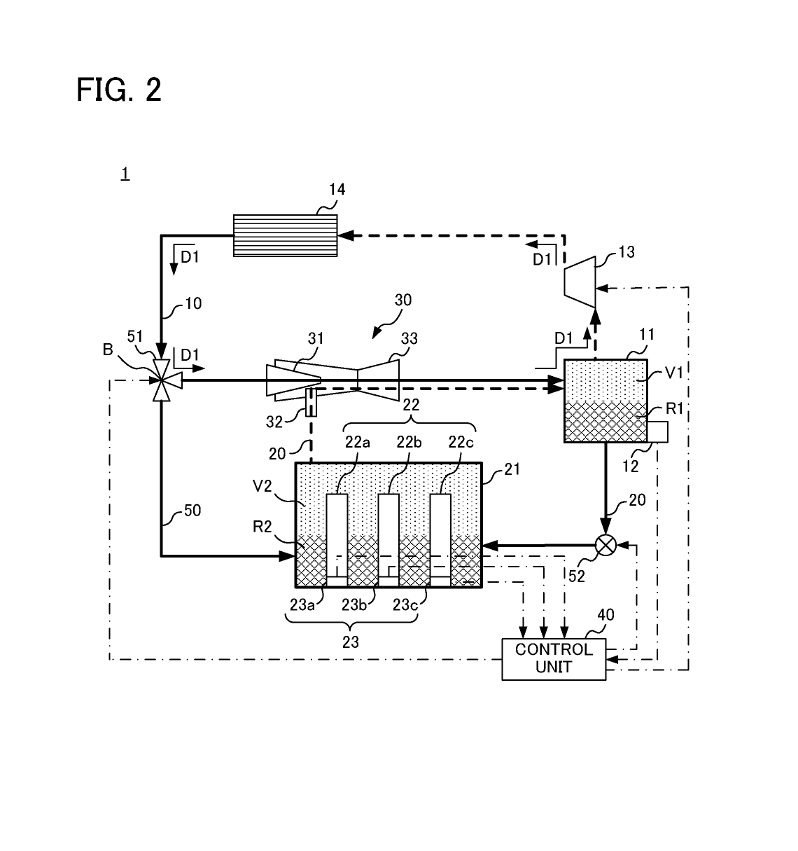

FIG. 2 is a diagram showing a configuration of the battery cooling apparatus 1 capable of switching the degree of cooling. The battery cooling apparatus 1 illustrated in FIG. 2 is different from the battery cooling apparatus 1 illustrated in FIG. 1 in that a third refrigerant flow path 50, a direction switching valve 51, and a flow regulating valve 52 are provided, and is the same in other respects. The third refrigerant flow path 50 is a flow path that branches from a branch point B provided downstream of the condenser 14 and upstream of the ejector 30 in the first refrigerant flow path 10, and allows the refrigerant R to flow into the battery case 21.

The direction switching valve 51 is a switching valve provided at the branch point B that switches whether the refrigerant R flows to the ejector 30 or to the battery case 21, and is, for example, a three-way valve. The direction switching valve 51 may be provided with a regulating valve for adjusting a flow rate of the refrigerant R flowing to the ejector 30 and a flow rate of the refrigerant R flowing to the battery case 21. The direction switching valve 51 may include a first two-way valve provided downstream of the branch point B and upstream of the ejector 30 in the first refrigerant flow path 10, and a second two-way valve provided downstream of the branch point B and upstream of the battery case 21 in the third refrigerant flow path 50. In this case, the first two-way valve and the second two-way valve may each include a regulating valve for adjusting the flow rate.

The flow regulating valve 52 is provided downstream of the tank 11 and upstream of the battery case 21 in the second refrigerant flow path 20, and is a regulating valve for adjusting the amount of the refrigerant R1 flowing from the tank 11 to the battery case 21. A pump may be provided upstream or downstream of the flow regulating valve 52 in the second refrigerant flow path 20.

In the battery cooling apparatus 1 illustrated in FIG. 2, the control unit 40 further controls the direction switching valve 51 and the flow regulating valve 52 by executing the programs stored in the storage unit, and switches the degree of cooling. For example, when the temperature of the batteries 22 is equal to or higher than a third threshold value, which is higher than the first threshold value, the control unit 40 determines to increase the degree of cooling (so-called high cooling is performed). The third threshold value is a temperature of the batteries 22 that can be estimated to have risen due to high outside air temperature or a high charging/discharging speed, and is, for example, a fixed value of 40°C or more and 45°C or less. Then, the control unit 40 performs high cooling by switching the direction switching valve 51 to allow the refrigerant to flow from the branch point B to the ejector 30, and by opening the flow regulating valve 52 to allow the refrigerant R1 to flow from the tank 11 to the battery case 21.

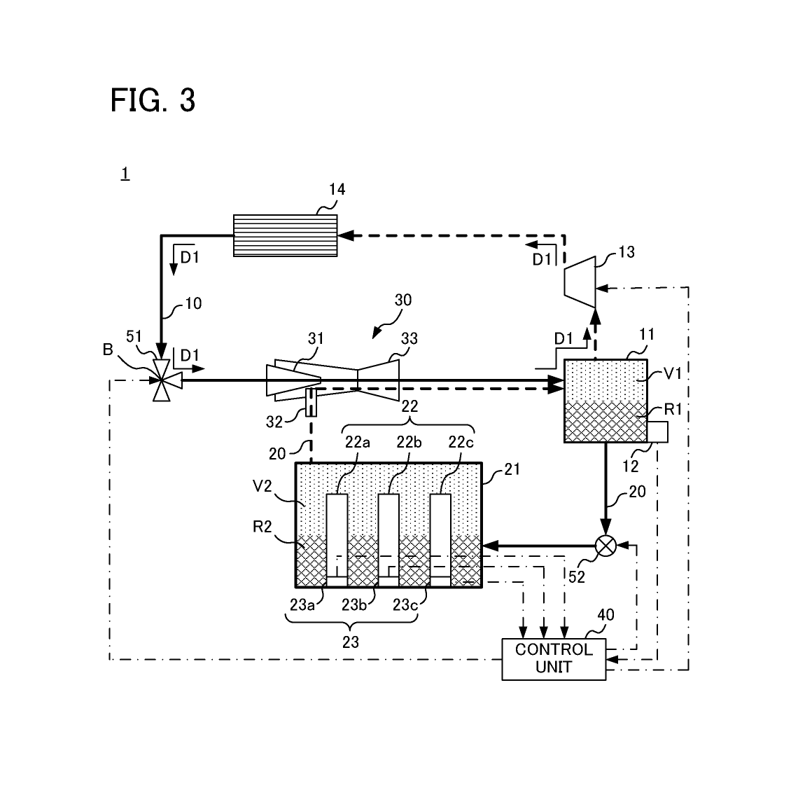

FIG. 3 is a diagram showing the battery cooling apparatus 1 performing high cooling. As illustrated in FIG. 3, the control unit 40 switches the direction switching valve 51 to allow the refrigerant R to flow from the condenser 14 to the ejector 30 and to prevent the refrigerant R from flowing from the condenser 14 into the third refrigerant flow path 50 (the battery case 21). The control unit 40 opens the flow regulating valve 52 to allow the refrigerant R1 to flow from the tank 11 to the battery case 21.

For example, the higher the temperature of the batteries 22 and the higher the outside air temperature, the more the control unit 40 increases the rotational speed of the compressor 13 and the opening degree of the flow regulating valve 52. When the pump is installed downstream of the tank 11 in the second refrigerant flow path 20, the higher the temperature of the batteries 22 is and the higher the outside air temperature is, the more the control unit 40 increases the rotational speed of the pump and the amount of the refrigerant R flowing to the battery case 21. By operating in this manner, the control unit 40 cools the batteries 22 so that the temperature of the batteries 22 falls within a range that is equal to or higher than the second threshold value and lower than the first threshold value. By having the control unit 40 operate as described above, the battery cooling apparatus 1 illustrated in FIG. 3 can cool the batteries 22 in the same manner as the battery cooling apparatus 1 illustrated in FIG. 1.

For example, when the temperature of the batteries 22 is lower than the third threshold value, the control unit 40 determines to reduce the degree of cooling (so-called low cooling is performed). Then, the control unit 40 performs low cooling by switching the direction switching valve 51 to allow the refrigerant R to flow from the branch point B to the battery case 21 and by closing the flow regulating valve 52 to prevent the refrigerant R1 from flowing from the tank 11 to the battery case 21.

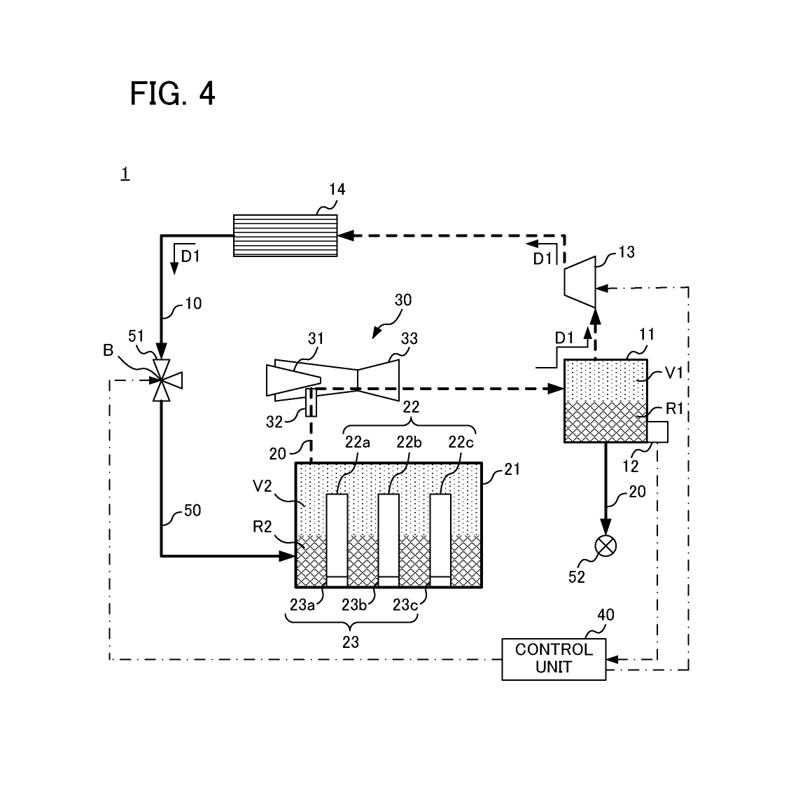

FIG. 4 is a diagram showing the battery cooling apparatus 1 performing low cooling. As illustrated in FIG. 4, the control unit 40 switches the direction switching valve 51 to allow the refrigerant R to flow from the condenser 14 into the third refrigerant flow path 50 (the battery case 21) and prevent the refrigerant R from flowing from the condenser 14 to the ejector 30. The control unit 40 closes the flow regulating valve 52 to prevent the refrigerant R1 from flowing from the tank 11 to the battery case 21.

By having the control unit 40 operate as described above, in the battery cooling apparatus 1, the condenser 14 condenses the amount of the vapor V1 corresponding to the rotational speed of the compressor 13 into the refrigerant R, and delivers the refrigerant R to the battery case 21. Next, the vapor V2, which is generated by vaporization of the refrigerant R included in the refrigerant R2 that has exchanged heat with the batteries 22 in the battery case 21, is stored in the tank 11 via the suction unit 32 and the first refrigerant flow path 10 by the rotation of the compressor 13.

Then, for example, the higher the temperature of the batteries 22 and the greater the amount of the refrigerant R1, the more the control unit 40 increases the rotational speed of the compressor 13. By controlling the rotational speed of the compressor 13 in this manner, the control unit 40 cools the batteries 22 so that the temperature of the batteries 22 falls within the range that is equal to or higher than the second threshold value and lower than the first threshold value.

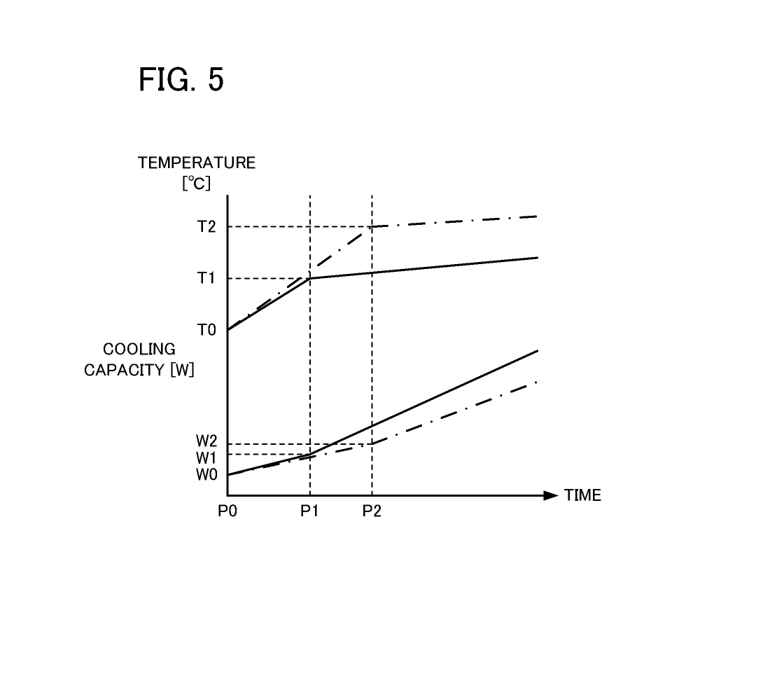

FIG. 5 is a diagram illustrating the temperature of the batteries 22 corresponding to the degree of cooling. The horizontal axis of FIG. 5 indicates time, and the vertical axis of FIG. 5 indicates the “temperature” of the batteries 22 and the “cooling capacity” of the battery cooling apparatus 1. In FIG. 5, the temperature and cooling capacity when the battery cooling apparatus 1 performs high cooling are indicated by solid lines, and the temperature and cooling capacity when the battery cooling apparatus 1 performs low cooling are indicated by one-dot chain lines.

When the battery cooling apparatus 1 performs low cooling (one-dot chain line), the pressure inside the battery case 21 does not decrease, and is, for example, 1 atm. Therefore, the boiling point of the refrigerant R2 does not decrease, and is, for example, 33°C. As a result, as shown in FIG. 5, the temperature of the batteries 22 rises to a temperature T2 at a time P2, and gradually increases from the temperature T2 after the time P2. On the other hand, when the battery cooling apparatus 1 performs high cooling (solid line), the pressure inside the battery case 21 decreases, for example, to 0.7 atm. Therefore, the boiling point of the refrigerant R2 decreases, for example, to 25°C. As a result, as shown in FIG. 5, the temperature of the batteries 22 rises to a temperature T1, which is lower than the temperature T2, at a time P1, and gradually increases from the temperature T1 after the time P1.

As described above, by having the control unit 40 switch between the high cooling shown in FIG. 3 and the low cooling shown in FIG. 4, the battery cooling apparatus 1 can switch the degree of cooling according to the state of charging and discharging of the batteries 22 or the state of whether cooling of the batteries 22 is easy or not. As a result, the battery cooling apparatus 1 can cool the batteries 22 so that the temperature of the batteries 22 falls within the temperature range in which degradation of the batteries 22 is unlikely to be promoted.

In the above description, the operation based on whether the temperature of the batteries 22 is equal to or higher than the third threshold value is exemplified, but the control unit 40 may control the degree of cooling on the basis of whether rapid charging is performed. For example, the control unit 40 acquires, from an external information processing apparatus, charging information indicating whether charging of the batteries 22 is rapid charging or normal charging. In a case where charging information indicating normal charging is acquired, the control unit 40 performs low cooling. That is, when the charging information indicating normal charging is acquired, the control unit 40 switches the direction switching valve 51 to allow the refrigerant R to flow from the branch point B to the battery case 21 and closes the flow regulating valve 52 to prevent the refrigerant R1 from flowing from the tank 11 to the battery case 21.

On the other hand, when charging information indicating rapid charging is acquired, the control unit 40 increases the degree of cooling (so-called high cooling) on condition that the outside air temperature is higher than a predetermined temperature and the temperature of the batteries 22 is higher than the first threshold value. That is, when the charging information indicating rapid charging is acquired, the control unit 40 switches the direction switching valve 51 to allow the refrigerant to flow from the branch point B to the ejector 30 and opens the flow regulating valve 52 to allow the refrigerant R1 to flow from the tank 11 to the battery case 21, on condition that the outside air temperature is higher than the predetermined temperature and the temperature of the batteries 22 is higher than the first threshold value. By operating as described above, the control unit 40 can perform the high cooling in the rapid charging, so that the temperature of the batteries 22 can be prevented from rapidly rising. As a result, the battery cooling apparatus 1 can suppress acceleration of degradation of the batteries 22.

In a case where the charging information indicating the rapid charging is acquired, the control unit 40 may decrease the third threshold value. For example, when the charging information indicating rapid charging is acquired, the control unit 40 reduces the third threshold value indicating 45°C to 35°C. By operating in this manner, the control unit 40 can perform high cooling before the temperature of the batteries 22 rises and cooling of the batteries 22 becomes difficult. As a result, it becomes easier to suppress an increase in the temperature of the batteries 22 to a temperature at which degradation of the batteries 22 is promoted.

Even when the control unit 40 does not acquire the charging information indicating rapid charging, the control unit 40 may perform high cooling by satisfying predetermined conditions. For example, the control unit 40 identifies a road surface condition corresponding to the position of the vehicle provided with the battery cooling apparatus 1 on the basis of the position of the vehicle included in position information acquired from GPS (Global Positioning System). The road surface condition is, for example, the magnitude of the gradient of the road surface and the distance of the gradient. The control unit 40 determines whether to perform high cooling on the basis of the identified road surface condition. For example, the control unit 40 performs high cooling on condition that the magnitude of the gradient of the road surface ahead in the traveling direction of the vehicle is equal to or greater than a predetermined magnitude and the distance of the gradient of the road surface is equal to or greater than a predetermined distance.

### Process Sequence in the Battery Cooling Apparatus 1

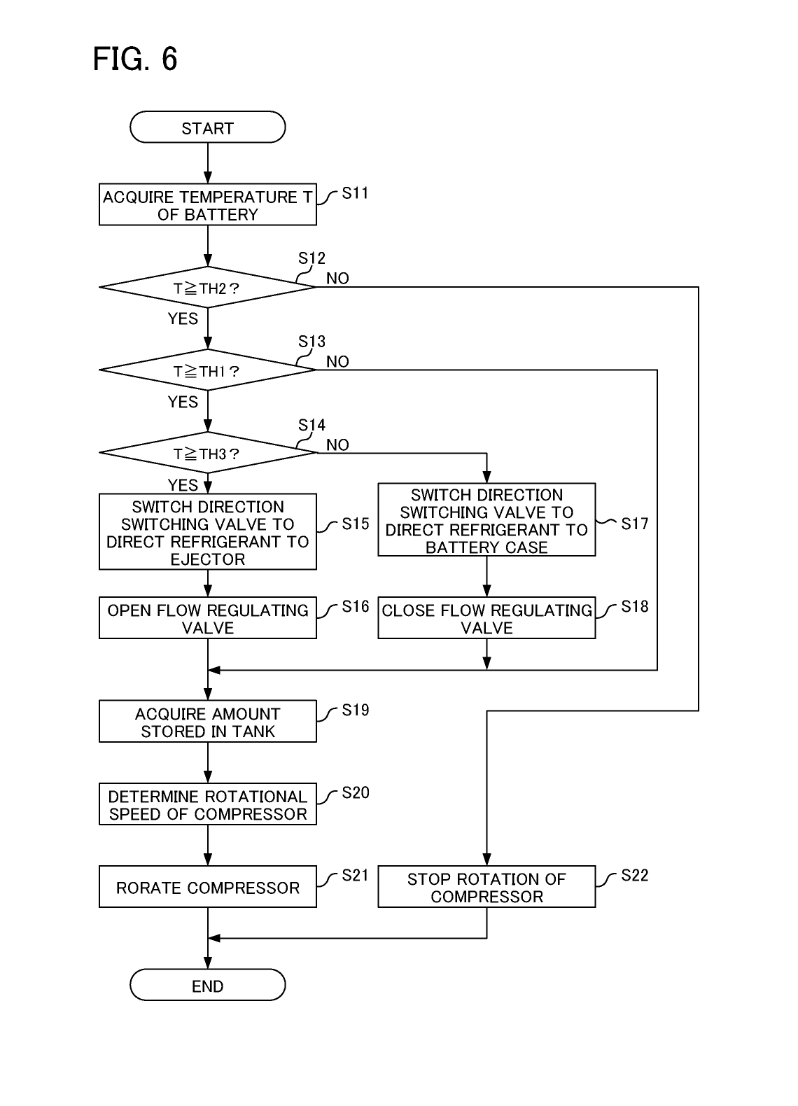

FIG. 6 is a diagram illustrating an example of a processing sequence in the battery cooling apparatus 1. The processing sequence illustrated in FIG. 6 is a processing sequence illustrating a process in which the battery cooling apparatus 1 cools the batteries 22. The battery cooling apparatus 1 repeats, for example, the processing sequence shown in FIG. 6 every predetermined unit time (for example, 10 seconds).

The control unit 40 acquires a temperature T of a battery detected by the temperature sensor 23 (S11). When there are a plurality of temperature sensors 23, the control unit 40 calculates the maximum value of the temperatures T detected by the respective temperature sensors 23, and acquires the maximum value as the temperature T. If the temperature T is less than a second threshold value Th2 (NO in S12), the control unit 40 stops the rotation of the compressor 13 (S22), and ends the process. If the temperature T is equal to or higher than the second threshold value Th2 (YES in S12), the control unit 40 determines whether the temperature T is equal to or higher than a first threshold value Th1 (S13).

If the temperature T is equal to or higher than the first threshold value Th1 (YES in S13), the control unit 40 determines whether the temperature T is equal to or higher than a third threshold value Th3 (S14). If the temperature T is equal to or higher than the third threshold value Th3 (YES in S14), the control unit 40 switches the direction switching valve 51 to allow the refrigerant R to flow to the ejector 30 (S15), and opens the flow regulating valve 52 (S16). If the temperature T is less than the third threshold value Th3 (NO in S14), the control unit 40 switches the direction switching valve 51 to allow the refrigerant R to flow to the battery case 21 (S17), and closes the flow regulating valve (S18). If the temperature T is less than the first threshold value Th1 (NO in S13), the control unit 40 maintains the control of the direction switching valve 51 and the flow regulating valve 52 performed in the preceding unit time.

The control unit 40 acquires the amount of the refrigerant R1 detected by the remaining-amount sensor 12 (S19), and determines the rotational speed of the compressor 13 on the basis of the temperature T of the batteries 22 and the amount of the refrigerant R1 (S20). The control unit 40 rotates the compressor at the determined rotational speed (S21).

### First Modification

In the above description, the operation has been exemplified in which the control unit 40 controls the rotational speed of the compressor 13 on the basis of the temperature T of the batteries 22, but the operation is not limited thereto. The control unit 40 may control the rotational speed of a fan included in the condenser 14 on the basis of the temperature T. For example, the higher the temperature T, the more the control unit 40 increases the rotational speed of the fan. By operating in this manner, the battery cooling apparatus 1 can reduce the rotational speed of the fan when the temperature T of the batteries 22 is low, so that power consumption can be suppressed.

### Second Modification

In the above description, the operation has been exemplified in which the higher the temperature T of the batteries 22, the more the control unit 40 increases the rotational speed of the compressor 13 and the rotational speed of the fan included in the condenser 14, but the operation is not limited thereto. The control unit 40 may determine the rotational speed of the compressor 13 and the rotational speed of the fan according to the degree of cooling by referencing the rotational speeds of the compressor 13 and the fan, respectively, corresponding to high operation and low operation, which are stored in the storage unit.

Furthermore, the control unit 40 may determine the rotational speed of the compressor 13 and the rotational speed of the fan corresponding to the temperature T by referencing the rotational speeds of the fan corresponding to respective temperature ranges and the rotational speeds of the compressor 13 corresponding respectively to high operation and low operation, which are stored in the storage unit. By operating in this manner, the control unit 40 can reduce the processing load required to determine the rotational speed of the compressor 13. Furthermore, the control unit 40 can further adjust the degree of cooling by the rotational speed of the fan in each of high operation and low operation.

### Third Modification

In the above description, the operation has been exemplified in which the control unit 40 controls whether the refrigerant R flows into the nozzle 31 according to whether the compressor 13 is caused to rotate, but the operation is not limited thereto. The control unit 40 may adjust the flow rate and velocity of the refrigerant R flowing into the ejector 30 by controlling the opening degree of a flow regulating valve (not shown) provided downstream of the condenser 14 and upstream of the nozzle 31 in the first refrigerant flow path 10. For example, the higher the temperature T of the batteries 22, the more the control unit 40 increases the opening degree of the flow regulating valve.

### Fourth Modification

In the above description, the operation has been exemplified in which the nozzle diameter of the nozzle 31 is constant, but the operation is not limited thereto. The nozzle diameter of at least one end of the nozzle 31 may be variable.

### Fifth Modification

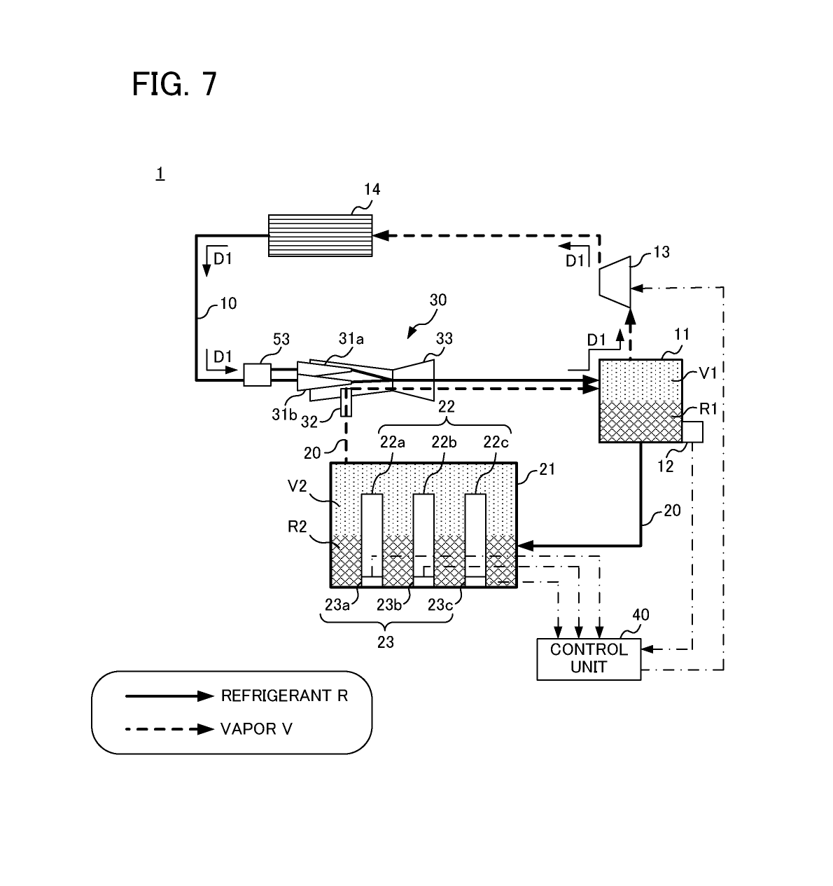

In the above description, the ejector 30 having one nozzle 31 is exemplified, but the present disclosure is not limited thereto. The ejector 30 may include a plurality of nozzles 31 among which at least one end of a nozzle 31 has a nozzle diameter different from that of the other nozzles 31. FIG. 7 is a diagram illustrating a configuration of a battery cooling apparatus 1 according to a fifth modification. The battery cooling apparatus 1 illustrated in FIG. 7 is different from the battery cooling apparatus 1 illustrated in FIG. 1 in that it includes a first nozzle 31a, a second nozzle 31b, and a nozzle switching valve 53, and is the same in other respects.

The ejector 30 includes, as the nozzles 31, the first nozzle 31a having a first nozzle diameter and the second nozzle 31b having a second nozzle diameter that is smaller than the first nozzle diameter. The nozzle switching valve 53 is provided upstream of the first nozzle 31a and the second nozzle 31b and downstream of the condenser 14 in the first refrigerant flow path 10, and switches whether to have the refrigerant R flow from the first nozzle 31a or from the second nozzle 31b.

When the temperature T of the batteries 22 is equal to or higher than the first threshold value Th1, the control unit 40 switches the nozzle switching valve 53 to allow the refrigerant R to flow from the first nozzle 31a. On the other hand, when the temperature T of the batteries 22 is lower than the first threshold value Th1, the control unit 40 switches the nozzle switching valve 53 to allow the refrigerant R to flow from the second nozzle 31b. The control unit 40 may switch the nozzle switching valve 53 to allow the refrigerant R to flow from the first nozzle 31a when the temperature T is equal to or higher than the third threshold value Th3, and may switch the nozzle switching valve 53 to allow the refrigerant R to flow from the second nozzle 31b when the temperature T is lower than the third threshold value Th3.

### Sixth Modification

In the above description, the operation has been exemplified in which the control unit 40 acquires the amount of the refrigerant R1 stored in the tank 11 detected by the remaining-amount sensor 12, but the operation is not limited thereto. The control unit 40 may identify the amount of the refrigerant R1 on the basis of the amount of the refrigerant R2 stored in the battery case 21 and detected by a sensor (not shown) provided in the battery case 21.

### Effects of the Battery Cooling Apparatus 1

As described above, the battery cooling apparatus 1 includes: the battery case 21 that houses the refrigerant R, which is a liquid for cooling the batteries 22, and the batteries 22 with at least a part thereof immersed in the refrigerant R; the first refrigerant flow path 10 through which the refrigerant R, a portion of which is supplied to the battery case 21, and the vapor V generated by vaporization of the refrigerant R flow; and the ejector 30 provided in the first refrigerant flow path 10 and through which the refrigerant R and the vapor V pass, wherein the ejector 30 includes: the nozzle 31 into which the refrigerant R flowing through the first refrigerant flow path 10 flows; the suction unit 32 that draws in the vapor V generated by the vaporization of the refrigerant R contained in the battery case 21; and the discharge unit 33 that discharges the refrigerant R that has flowed into the nozzle 31 and the vapor V drawn in by the suction unit 32 into the first refrigerant flow path 10.

With the battery cooling apparatus 1 configured as described above, in the battery cooling apparatus 1, the pressure in the battery case 21 is reduced, lowering the boiling point of the refrigerant R2 in the battery case 21, thereby facilitating evaporation (vaporization) of the refrigerant R2. As a result, the battery cooling apparatus 1 can facilitate cooling of the batteries 22.

The present disclosure is explained based on the exemplary embodiments. The technical scope of the present disclosure is not limited to the scope explained in the above embodiments and it is possible to make various changes and modifications within the scope of the disclosure. For example, all or part of the apparatus can be configured with any unit which is functionally or physically dispersed or integrated. Further, new exemplary embodiments generated by arbitrary combinations of them are included in the exemplary embodiments. Further, effects of the new exemplary embodiments brought by the combinations also have the effects of the original exemplary embodiments.

What is claimed is:

1. A battery cooling apparatus comprising:
a battery case that houses a refrigerant, which is a liquid for cooling a battery, and a battery with at least a part thereof immersed in the refrigerant;
a first refrigerant flow path through which the refrigerant, a portion of which is supplied to the battery case, and vapor generated by vaporization of the refrigerant flow; and
an ejector provided in the first refrigerant flow path and through which the refrigerant and the vapor pass, wherein the ejector includes a nozzle into which the refrigerant flowing through the first refrigerant flow path flows, a suction unit that draws in the vapor generated by the vaporization of the refrigerant contained in the battery case as the refrigerant passes through the ejector, and a discharge unit that discharges the refrigerant that has flowed into the nozzle and the vapor drawn in by the suction unit into the first refrigerant flow path.

2. The battery cooling apparatus according to claim 1, further comprising:
a tank that is provided downstream of the ejector in the first refrigerant flow path and stores the refrigerant and the vapor discharged from the ejector;
a compressor that is provided downstream of the tank in the first refrigerant flow path and compresses the vapor stored in the tank;
a condenser that is provided downstream of the compressor and upstream of the ejector in the first refrigerant flow path and condenses the vapor compressed by the compressor into the refrigerant; and
a second refrigerant flow path through which the refrigerant flows from the tank to the battery case, and the vapor flows from the battery case to the suction unit.

3. The battery cooling apparatus according to claim 2, further comprising:
a control unit that causes the compressor to rotate when the temperature of the battery is equal to or higher than a first threshold value, and stops the rotation of the compressor when the temperature of the battery is lower than a second threshold value which is lower than the first threshold value.

4. The battery cooling apparatus according to claim 3, wherein the higher the temperature of the battery, the more the control unit increases the rotational speed of the compressor.

5. The battery cooling apparatus according to claim 3, wherein the control unit controls the rotational speed of the compressor on the basis of an amount of the refrigerant stored in the tank.

6. The battery cooling apparatus according to claim 3, further comprising:
a third refrigerant flow path that branches from a branch point provided downstream of the condenser and upstream of the ejector in the first refrigerant flow path and allows the refrigerant to flow into the battery case;
a direction switching valve that is provided at the branch point and switches whether the refrigerant flows to the ejector or to the battery case; and
a flow regulating valve that is provided downstream of the tank and upstream of the battery case in the second refrigerant flow path and adjusts the amount of the refrigerant flowing from the tank to the battery case.

7. The battery cooling apparatus according to claim 6, wherein the control unit switches the direction switching valve to allow the refrigerant to flow from the branch point to the ejector, and opens the flow regulating valve to allow the refrigerant to flow from the tank to the battery case when the temperature of the battery is equal to or higher than a third threshold value that is higher than the first threshold value.

8. The battery cooling apparatus according to claim 7, wherein the control unit switches the direction switching valve to allow the refrigerant to flow from the branch point to the battery case, and closes the flow regulating valve to prevent the refrigerant from flowing from the tank to the battery case when the temperature of the battery is less than the third threshold value.

9. The battery cooling apparatus according to claim 3, wherein the ejector includes, as the nozzle, a first nozzle having a first nozzle diameter and a second nozzle having a second nozzle diameter that is smaller than the first nozzle diameter, and further includes a nozzle switching valve that is provided upstream of the first nozzle and the second nozzle and downstream of the condenser in the first refrigerant flow path and switches whether to have the refrigerant flow from the first nozzle or from the second nozzle, wherein the control unit switches the nozzle switching valve to allow the refrigerant to flow from the first nozzle when the temperature of the battery is equal to or higher than the first threshold value, and switches the nozzle switching valve to allow the refrigerant to flow from the second nozzle when the temperature of the battery is lower than the first threshold value.

10. The battery cooling apparatus according to claim 5, wherein the smaller an amount of the refrigerant, the more the control unit increases the rotational speed of the compressor.

11. The battery cooling apparatus according to claim 7, wherein the higher the temperature of the battery and the higher an outside air temperature, the more the control unit increases the rotational speed of the compressor and the opening degree of the flow regulating valve.

12. The battery cooling apparatus according to claim 7, wherein the control unit reduces the third threshold value when charging information indicating rapid charging is acquired.

13. The battery cooling apparatus according to claim 6, wherein the control unit switches the direction switching valve to allow the refrigerant to flow from the branch point to the ejector and opens the flow regulating valve to allow the refrigerant to flow from the tank to the battery case, on condition that outside air temperature is higher than a predetermined temperature and the temperature of the battery is higher than the first threshold value, when charging information indicating rapid charging is acquired.

14. The battery cooling apparatus according to claim 13, wherein the control unit switches the direction switching valve to allow the refrigerant to flow from the branch point to the battery case, and closes the flow regulating valve to prevent the refrigerant from flowing from the tank to the battery case when charging information indicating normal charging is acquired.
